(19) United States
(12) Patent Application Publication
(10) Pub. No.: US 2002/0014134 A1
(43) Pub. Date: Feb. 7, 2002

(54) Method for manual shifting of a multi-section transmission

(76) Inventor: Friedrich J. Ehrlinger, Friedrichshafen (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/909,200

(22) Filed: Jul. 19, 2001

(30) Foreign Application Priority Data
Jul. 27, 2000 (DE) 100 36 511.6

(51) Int. Cl. F16H 3/02

(52) U.S. Cl. 74/745

(57) ABSTRACT

The method for manual shifting of a multi-section transmission which has at least one hand-shiftable main transmission with one input constant and one rear-mounted range change group consists in that the rear-mounted range change group is shifted to the neutral position during initiation of and prior to carrying out the shifting operation of the main transmission.

This invention concerns a method for manual shifting of a multi-section transmission which has at least one manually shiftable main transmission with one input constant and one rear-mounted range change group.

Commercial truck transmissions have from 4 to 6 gears depending on the type of vehicle and utilization thereof. With up to four gears, the ratios are implemented without group transmissions. Transmissions with 8 gears generally have one range change group, 16-gear transmissions are mostly equipped with a range change group and with a splitter group.

FR 15 05 190 has disclosed a device for shifting motor vehicles transmission consisting of one main transmission, wherein upon a gear change a clutch between the engine and the main transmission is opened and of one rear-mounted transmission wherein devices are provided which, during gear change act, upon the rear-mounted transmission which preferably is an overdrive transmission. The devices serve to prevent overspeed of the engine when charging down the main transmission.

GB 753 200 has disclosed a driving device, having one main transmission and one rear-mounted group transmission, there being provided as the main transmission a planetary gear shiftable by means of friction shifting elements and as the group transmission a countershaft transmission with synchronizing devices, there being no main clutch. In view of this, the group transmission can be shifted only under load discontinuation, that is, in a neutral position of the main transmission. In this transmission construction, since the vehicle mass is firmly connected with the secondary parts of the synchromesh transmission, the synchronization work is very great especially in the lower gears causing shifting difficulties.

In order to reduce the manual shifting forces during shifting operations in a multi-section transmission consisting at least one main transmission and one group transmission, and suited for heavy commercial devices, it has already been proposed in the Applicant's DE 20 05 636 to adjust, during the shifting operation, a low differential rotational speed which is to be bridged by the synchronizers. This results with the aid of an electrohydraulic shifting device wherein the rear-mounted transmission is provided with friction shifting elements and wherein the active friction element for the lower gear of the group transmission is opened during gear change in the main transmission. To control the friction shifting elements in the group transmission, an electrohydraulic 3/3 directional valve is provided the current supply of which is interrupted in the lower gears during the gear changes by a switch according to the position of the group selector switch. It is, likewise, necessary to open the friction shifting element provided for the shifting operation of the group transmission during the shifting operation of the main transmission.

A method of main shaft synchronization of a transmission of shifting system having range change group shifting, a transmission electronic system, a passive interlock and optionally a temperature sensor has been disclosed in the Applicant's DE 197 26 567. This method serves to press the cold shifting limit to a level harmless for the shifting, the main shaft being synchronized with the aid of the prime mover. Therefore, this is an automatic transmission with electronic gear shifting with which is to be obtained that in the cold state during travel, when downshifting from the quick to the slow range group of the rear-mounted transmission, the shifting operation can be carried out to the end by lowering the cold shifting limit to a level harmless to the shifting so that the downshift can be performed in the slow direction in adequate time. To this end, the transmission electronic system is equipped with a special software program which, according to measured and calculated parameters, effects the synchronization of the transmission main shaft.

The problem on which this invention is based is to provide a method for manual shifting of a multi-section transmission with which the manual shifting forces required for the shifting operation in the main transmission can be reduced.

Based on a method of the kind above described in detail, this problem is solved with the feature stated in the characteristic part of claim 1; advantageous developments are described in the sub-claims.

It is, therefore, proposed that according to the invention during initiation of the shifting operation and prior to carrying it out in the main transmission, the rear-mounted range change group is switched to the neutral position.

This gear shift to the neutral position can be automatic; after terminating the shifting operation of the transmission, the rear-mounted range change group is advantageously brought by engine synchronization to synchronous speed with the main transmission and thereafter is engaged again.

The engagement of the rear-mounted range change group can result by means of a dog clutch operating control existing in the rear-mounted range change group or by means of a dog clutch operation control existing in the main transmission.

During the gear shift operations, the starting clutch of the drive train no longer has to be opened but can be retained in its closed position.

The rear-mounted range change group is advantageously shifted to the neutral position by means of the sliding sleeve provided therein which is moved to its central position.

In another advantageous embodiment, it is possible to uncouple the whole rear-mounted range change group from the main transmission after shifting of the range change group to the neutral position. This requires an alternative shifting arrangement in the rear-mounted range change group.

This invention is especially adequate for a multi-section transmission having mechanical selector linkage between the driver's hand and the sliding sleeve, but it can also be used for multi-section group transmission wherein the manual shifting force is hydraulically transmitted. It offers a considerable reduction of the manual shifting forces to be applied in the main transmission by displacement of the synchronization of the main transmission to the rear, that is, toward the rear-mounted range change group instead of forward toward the starting clutch.

1. Method for manual shifting of a multi-section transmission which has at least one manually shiftable main transmission with one input constant and one rear-mounted range change group, characterized in that said rear-mounted range change group is shifted to the neutral position during initiation of the shifting operation of the main transmission and prior to carrying it out.

2. Method according to claim 1, characterized in that said rear-mounted range change group is automatically shifted to the neutral position.

3. Method according to claims 1 and 2, characterized in that after termination of the shifting operation of said main transmission, said rear-mounted range change group is brought to synchronous speed with said main transmission and thereafter engaged again.

4. Method according to claim 3, characterized in that the engagement of said rear-mounted range change group results by means of a dog clutch operating control existing therein.

5. Method according to claim 3, characterized in that the engagement of said rear-mounted range change group results by means of a dog clutch operating control existing in said main transmission.

6. Method according to any one of the preceding claims, characterized in that during the gear shift operations the starting clutch of the drive train is retained in its closed position.

7. Method according to any one of the preceding claims, characterized in that the shifting of said rear-mounted range change group to the neutral position results by means of the sliding sleeve provided therein which is moved to its central position.

8. Method according to claim 7, characterized in that after shifting of said rear-mounted range change group to the neutral position, the whole rear-mounted range change group is automatically uncoupled from said main transmission.
